(19) United States
(12) Patent Application Publication
(10) Pub. No.: US 2016/0335695 A1
(43) Pub. Date: Nov. 17, 2016

(54) Network-Based Property Searching System Having Optimized Search Engine

(71) Applicants: Rahul Gokhale, Wayne, NJ (US); Swaraj Nankar, Bernardsville, NJ (US)

(72) Inventors: Rahul Gokhale, Wayne, NJ (US); Swaraj Nankar, Bernardsville, NJ (US)

(21) Appl. No.: 14/711,357

(22) Filed: May 13, 2015

(51) Int. Cl. G06Q 30/06; G06Q 50/16; G06F 17/30

(52) U.S. Cl. CPC G06Q 30/0627; G06F 17/30867; G06F 17/30241; G06F 17/3087; G06Q 50/16

(57) ABSTRACT

A network-based property searching system having optimized search engine is disclosed herein. The property searching system comprising a computer system in electronic communication with an end user computer system and one or more remote data sources over a network, an optimization database including at least one pre-programmed database table identifying a geographic location and a plurality of geographic areas within a predetermined distance of the geographic location, an optimization engine which causes the computer system to: electronically receive over the network search criteria including a workplace location and commute criteria, querying the optimization database to identify a plurality of geographic areas to be searched that each satisfy the search criteria, electronically querying over the network the one or more remote data sources to identify individual properties located within the plurality of geographic areas to be searched, filtering the individual properties based on the search criteria.

### BACKGROUND

1. Field of the Disclosure

The present disclosure relates generally to computer search engine technology. More specifically, the present invention relates to a network-based property searching system having an optimized search engine.

2. Related Art

Home searching over the Internet is a growing market. There are more than 500 million visits to home search websites every month and the unique visitor count is in excess of 50 million per month. This number could increase as more home buyers begin to leverage technology for home buying.

Currently, many real estate Internet search tools require a home buyer to pre-determine the city or town of interest. Further, the search features for many of these search tools are limited in scope to things such as price range, number of bedrooms or bathrooms, type of house, etc. As a result, fundamental parameters in home decision making (e.g., user's work location, a spouse's work location, commute time, school preference, down payment amount, monthly mortgage budget, etc.) are neglected and not taken into consideration. Part of the reason for this is that to incorporate such parameters can be computationally intensive.

As a result, there is a need for a computationally fast and efficient property search tool that simplifies and improves the home search (e.g., buying, renting) experience, optimizes the search for increased speed, and incorporates fundamental parameters (e.g., commute time, total cost of ownership, school ratings, safety ratings, etc.).

### SUMMARY

The present disclosure relates to network-based property searching system having an optimized search engine, and associated methods. The system and method of the present disclosure optimizes property searching by applying a search optimization filter (e.g., zip code filter) to minimize the amount of properties to search. Further, unlike other systems that require a user to pre-determine the city or town of desired residency, the system and method of the present disclosure utilizes property search parameters that are fundamental to residency decisions, such as a user's work location, spouse's work location, commute time, school ranking preference, safety rating reference (e.g., based on crime statistics), down payment, monthly mortgage budget, etc. Further, the system and method of the present disclosure determines residency affordability (e.g., home buyer affordability) based on down payment and/or monthly mortgage budget (e.g., instead of listing price).

### BRIEF DESCRIPTION OF THE DRAWINGS

The foregoing features of the disclosure will be apparent from the following Detailed Description, taken in connection with the accompanying drawings, in which:

FIG. 1 is a diagram illustrating the system of the present disclosure, which allows for optimized property searching over a network;

FIG. 2 is a flowchart showing overall processing steps carried out by the system;

FIG. 3 illustrates school rating optimization carried out by the system;

FIG. 4 is a screenshot illustrating filtering by commute criteria in the property location filtering phase;

FIG. 5 is a screenshot illustrating a user interface generated by the system for allowing a user to specify search criteria, as well as filtering by commute criteria for multiple users;

FIG. 6 illustrates search logic in accordance with the system for identifying potential search candidates based on commute preferences of a plurality of users;

FIG. 7 is a screenshot illustrating results of property searching generated by the system of the present disclosure;

FIG. 8 is a screenshot illustrating additional information relating to property searches generated by the system of the present disclosure;

FIG. 9 is a flowchart showing overall processing steps carried out by the system for creating search optimization database tables utilized by the optimized search engine;

FIGS. 10A-10M illustrate search optimization database tables utilized by the optimized search engine; and

FIG. 11 is a diagram showing hardware and software components of the system.

### DETAILED DESCRIPTION

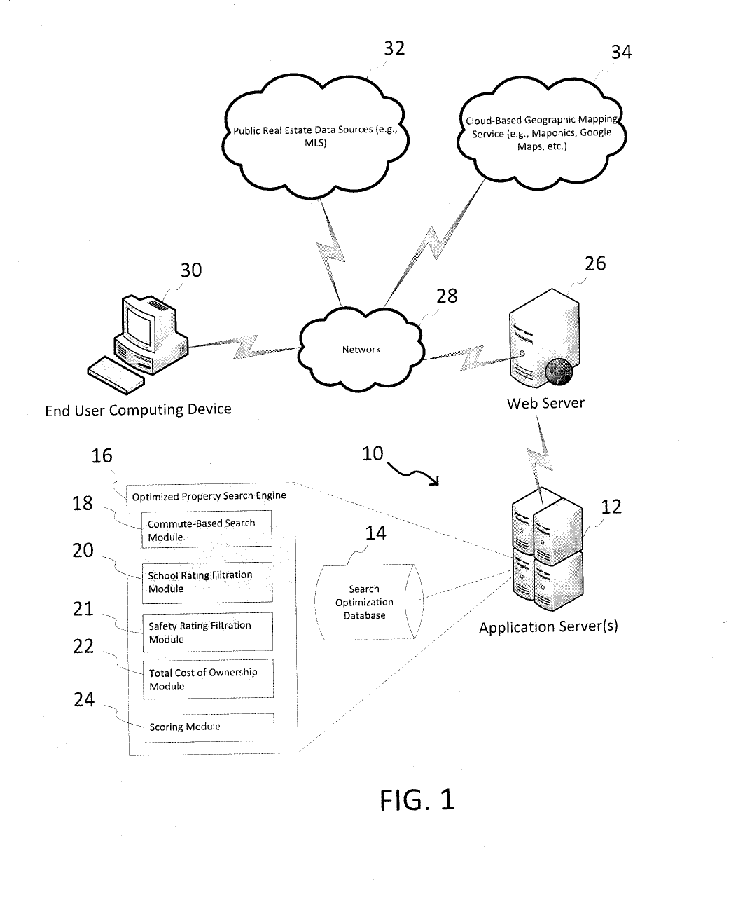

The present disclosure relates to a network-based property searching system having an optimized search engine, and associated methods, as discussed in detail below in connection with FIGS. 1-11. The system and method allows for computationally-efficient, high quality searches of properties (e.g., residencies) using an optimized search engine to remove large groups of properties before evaluating individual properties. The system provides results to a user which include a listing of all properties that meet the user's search criteria, a detailed breakdown for each property of all associated costs (e.g., estimated property maintenance cost, income tax credit, commute cost, etc.), actual commute time for each of one or more users (e.g., husband, wife, child, roommate, etc.) to commute to their work location (e.g., can evaluate the actual commute time for more than one work location), school ratings for nearby schools (e.g., preschool, elementary school, intermediate school, high school, etc.), and safety ratings (e.g., safety statistics, crime statistics) and other information. By the term “property,” it is meant real property (e.g., real estate) and associated dwellings to be purchased by individuals, as well as rental properties.

For home searching, the system finds all properties which a user can afford based on the down payment amount and total cost of ownership (e.g., monthly outgoing cash flow), such as bank installments, property taxes, hazard insurance, property mortgage insurance (PMI), association fees, tax benefits, property maintenance, commute costs (e.g., fuel costs), vehicle depreciation, etc. For rent searching, the system finds all properties which a user can afford based on total cost of renting (e.g., monthly outgoing cash flow), such as commute costs.

Additionally, the system calculates a property score which evaluates wasted spending associated with the property (e.g., property tax, commute cost, etc.). For a home owner, the property score measures the building of equity per dollar spent on total monthly costs. For a renter, the property score measures how much property (e.g., number of bedrooms and/or bathrooms) a user is getting for total monthly costs. The search results can be sorted by the property score (e.g., so that the property with the highest score is first). Further, the system calculates a commute score which is a measure of the actual driving, public transit, walking and/or biking time per user's commute choice. Moreover, the system incorporates school ratings, safety ratings, and/or other community ratings (e.g., including retirement, parks, night life, arts, etc.), etc. Thereby, the system finds all properties meeting a user's commute criteria (e.g., including time spend walking, biking, driving, taking public transit, etc.), school criteria (e.g., school ranking preference), safety criteria (e.g., safety ranking preference), and/or affordability parameters (e.g., mortgage budget, rent budget, etc.).

FIG. 1 is a diagram illustrating the system of the present disclosure, which allows for optimized property searching over a network, indicated generally at 10. The system 10 includes a computer system 12 (e.g., application server(s)) having a search optimization database 14 and an optimized real estate search engine 16, both in accordance with the present disclosure, stored therein. The computer system 12 could be any suitable computer server (e.g., a server with an INTEL microprocessor, multiple processors, multiple processing cores, etc.) running any suitable operating system (e.g., Windows by Microsoft, Linux, UNIX, etc.). The optimization database 14 could be stored on the computer system 12, or located externally therefrom (e.g., in a separate database server in communication with the system 10). The optimized real estate search engine 16 includes a commute-based search module 18, a school rating filtration module 20, a safety rating filtration module 21, a total cost of ownership module 22, and a scoring module 24, as discussed in more detail below.

The system 10 could be web-based and remotely accessible such that the system 10 communicates (e.g., via a web server 26) through a network 28 with one or more of a variety of end user computing devices 30 (e.g., personal computer system, a smart cellular telephone, a tablet computer, or other devices), public real estate data sources 32 (e.g., Multiple Listing Service (MLS)), and/or cloud-based geographic mapping service 34 (e.g., Maponics, Google Maps, etc.). Network communication could be over the Internet using standard TCP/IP communications protocols (e.g., hypertext transfer protocol (HTTP), secure HTTP (HTTPS), file transfer protocol (FTP), electronic data interchange (EDI), etc.), through a private network connection (e.g., wide-area network (WAN) connection, emails, electronic data interchange (EDI) messages, extensible markup language (XML) messages, file transfer protocol (FTP) file transfers, etc.), or any other suitable wired or wireless electronic communications format. Importantly, as will be discussed in greater detail below, the computer system 12 is a specially-programmed device which, due to the functionality provided by the optimization database 14 and the optimized search engine 16, drastically improves the speed and accuracy with which property search results can be electronically calculated and/or retrieved from the public data sources 32. The system could reduce network traffic and increases efficiency by reducing the number of queries (calls) that are needed to a database (e.g., cloud based) and/or public data sources 32 to search for properties.

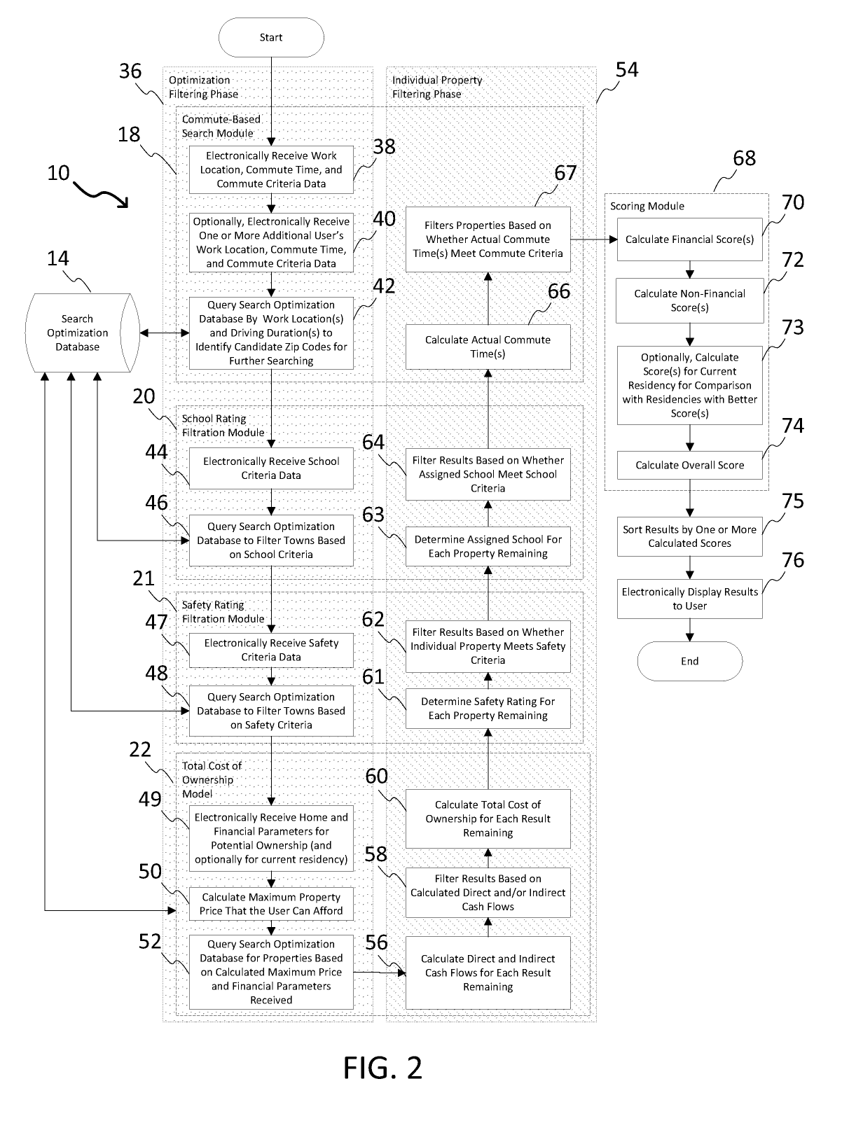

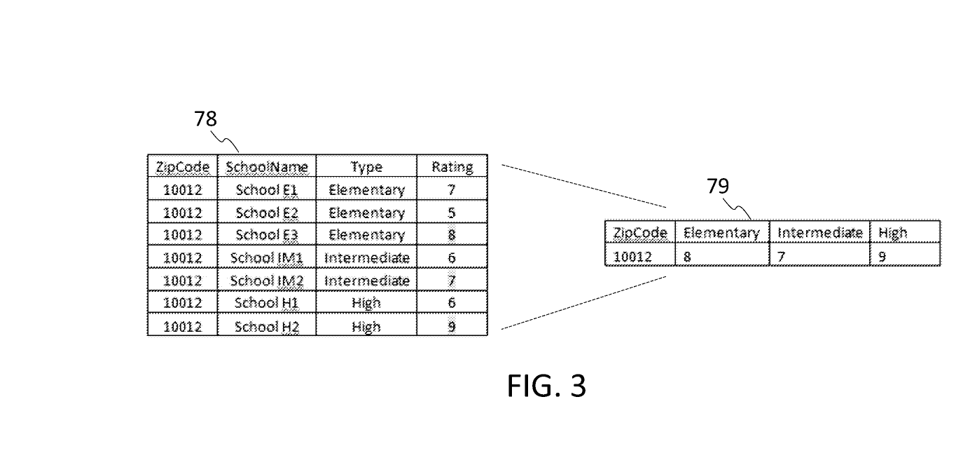

FIGS. 2-3 illustrate property search optimization carried out by the system of the present disclosure. FIG. 2 is a flowchart showing overall processing steps carried out by the system 10. In the optimization filtering phase 36 the system filter areas (e.g., zip codes, towns, cities, etc.), and corresponding groups of properties (e.g., homes for sale, apartments for rent, etc.), that do not meet the search criteria (e.g., commute preference/criteria data, school preference/criteria data, safety preference/criteria data, cost preference/criteria data, etc.) of the user. Search criteria further includes property preferences such as type of property (e.g., house, apartment, single, family, condo, etc.) and other property parameters (e.g., number of bedrooms, number of bathrooms, property size, etc.). In step 38 of the optimization filtering phase 36, the commute-based search module 18 electronically receives work location, commute time, and/or commute criteria data received from a user computing device. For example, the user could indicate where he/she works and how much time he/she is willing to spend in commute (e.g., by car, public transportation, biking, walking, etc.). In step 40 of the optimization filtering phase 36, the commute-based search module 18 optionally electronically receives one or more additional user's work location, commute time, and/or commute criteria data. As a result, the system could search for properties and areas that satisfy multiple user's commute criteria (e.g., husband, wife, child, roommate, etc.).

In step 42 of the optimization filtering phase 36, the commute-based search module 18 queries the search optimization database 14 by work location(s) and/or driving duration(s) to identify candidate zip codes for further searching. The optimization filter thereby provides a first level of optimization filtering which eliminates zip codes that do not meet the commute criteria (e.g., commute requirements). This could provide a first optimized list of zip codes (e.g., zipCodeList1) which satisfy the commute criteria for each of the one or more users.

In step 44 of the optimization filtering phase 36, the school rating filtration module 20 electronically receives school criteria data (e.g., minimum school rating for elementary school, middle school, and/or high school based on the Great Schools rating system) from an end user computing device. In step 46 of the optimization filtering phase 36, the school rating filtration module 20 queries the search optimization database to filter areas (e.g., zip codes, towns, cities, etc.) to filter towns based on the school criteria data.

The system 10 could filter areas based on school criteria data by creating zip code level data in the search optimization database 14. More specifically, for each zip code the system 10 could electronically obtain Maponics school boundary data and/or Great Schools ratings to identify the school assigned to each property within the zip code, and then associate the highest school rating for each type of school with that zip code. For example, if a particular zip code has three elementary schools, two intermediate schools, and two high schools, as shown in the school rating table 78 (“SchoolRatingTb”) of FIG. 3, then the system takes the maximum rating for each type of school in that zip code, as shown in the zip code school rating table 79 (“ZipSchooRatingTb”) of FIG. 3. Thereby the optimization filter provides a second level of optimization filtering by eliminating zip codes which do not meet the school criteria. This could provide a second optimized list of zip codes (e.g., zipCodeList2) which satisfies the commute criteria and school criteria (e.g., eliminates zip codes from zipCodeList1 which do not satisfy the school criteria).

In step 47 of the optimization filtering phase 36, the safety rating filtration module 21 electronically receives safety criteria data from an end user computing device. The safety criteria data could indicate high safety, medium safety, low safety, or indifference. In step 48 of the optimization filtering phase 36, the safety rating filtration module 21 queries the search optimization database to filter areas (e.g., zip codes, towns, cities, etc.) to filter towns based on the safety criteria data.

The system 10 could filter areas based on safety criteria data by creating zip code level data in the search optimization database 14. More specifically, for each zip code the system 10 could electronically obtain multiple crime data records (e.g., Citi-data) to identify areas (e.g., neighborhoods) associated with vary levels of crime (e.g., high, medium, low, etc.). For example, if a particular zip code has three towns, then the system takes the maximum rating for those three towns. Thereby the optimization filter provides a third level of optimization filtering by eliminating zip codes which do not meet the safety criteria. This could provide a third optimized list of zip codes (e.g., zipCodeList3) which satisfies the commute criteria, school criteria, and safety criteria.

In step 49 of the optimization filtering phase 36, the total cost of ownership module 22 electronically processes financial parameters to determine a total cost of ownership associated with a property. Financial parameters could include the type of house (e.g., single family, condo, townhouse, etc.), minimum number of bedrooms, minimum number of bathrooms, down payment, maximum monthly mortgage cash flow, private mortgage insurance (PMI), property insurance, fuel cost (e.g., for commute), loan term, etc. Further, the system could calculate maximum monthly outgoing cash flow towards home ownership based on yearly gross income, debts, etc. (e.g., lenders may not allow more than 40-45% of monthly gross income to go towards all debt payments include home, car, etc.). Based on these financial parameters, the system calculates the maximum property price (e.g., based on down payment and monthly cash flow). This provides an accurate assessment of affordability, although alternatively the system could ask the user for property price (e.g., and then search sale listings from the Multiple Listing Services (MLS) that are stored in a local or remote database).

In step 50 of the optimization filtering phase 36, the total cost of ownership module 22 calculates the maximum property price that the user can afford (e.g., based on the down payment). For example, if a user has a $40,000 down payment, and considering a minimum 5% down payment requirement, the maximum property price for a house would be $800,000 (e.g., $40,000/0.05). The system 10 could calculate a maximum price based on the assumption that all monthly cash flows are going toward the property payment (e.g., mortgage payment, rent payment).

As discussed in further detail below, the system could calculate a first maximum price based on down payment amount, then calculate a maximum price based on cash flow, take the lower of the two as the third maximum price, and then incorporate taxes, property mortgage insurance (PMI), insurance, etc. into the cash flow to calculate a fourth maximum price (e.g., lower than the third maximum price). For example, if a user is willing to put $2,000 per month towards home ownership and $500 per month is required to pay off a $100,000 loan with a 30 year, 4.4% interest rate mortgage, then the user can borrow $400,000 (e.g., 2000/500). With a $40,000 down payment, the maximum affordable house for the user would be $440,000. The system 10 then calculates a revised maximum price by incorporating other financial parameters that effect monthly cash flow (e.g., property taxes, PMI, property insurance, etc.) and further reduce the maximum property price. Continuing the example, if money spent on taxes, PMI, property insurance, etc. is $800 for a $440,000 house, then the cash flow remaining is $2000-$800=$1200, which reduces the maximum property price to $280,000, which is the $40,000 down payment plus $240,000 (the amount a user can borrow at $1,200 per month).

In step 52 of the optimization filtering phase 36, the total cost of ownership module queries the search optimization database 14 for properties (e.g., further filters the results of the safety rating filtration module 21) based on the calculated maximum price and/or the financial parameters received. More specifically, for example, the system queries the database (e.g., remote or local) to electronically retrieve all MLS listings of the zip codes that match the search criteria (e.g., commute criteria, school criteria) and that have a listing price less than or equal to the fourth maximum price calculated. For example, the system could obtain data from the Multiple Listing Service (MLS), which lists property price associated with each house. Such MLS data could be retrieved (e.g., daily) and stored in a local or remote database such that the database is continually updated (e.g., daily). Thereby the optimization filter provides a fourth level of optimization filtering by reducing the number of properties for which the system must calculate individual cash flows, which can be a computational and time-intensive process.

The process then proceeds to the individual property filtering phase 54 to evaluate and filter individual properties that do not meet the search criteria of the user. In step 56 of the individual property filtering phase 54, the total cost of ownership module 22 calculates monthly direct cash flow and monthly indirect cash flows for each property remaining.

For renting, monthly direct cost could include monthly rent and fuel costs, and the monthly indirect cost could include vehicle depreciation. For home ownership, monthly direct cost could include bank installment payments (e.g., principal plus interest), property taxes, private mortgage insurance (PMI) if down payment is less than 20%, property insurance, association fee (if applicable), fuel cost for commute. For home ownership, monthly indirect cost could include property maintenance, vehicle depreciation, tax benefits (e.g., credit received based on property taxes and interested paid).

In step 58 of the individual property filtering phase 54, the total cost of ownership module 22 further filters the results based on calculated direct and/or indirect cash flows (e.g., total monthly cost of owning). If the direct cost (and indirect cost) is more than the direct and indirect cash flows, then the house is removed. For example, the system could calculate the monthly cost for each property remaining, and eliminate any property where the direct monthly cost is more than a user's direct monthly cash flow. Then the system could calculate the indirect monthly cost for each property then remaining. In step 60 of the individual property filtering phase 54, the total cost of ownership module 22 calculates total cost of ownership for each result (e.g., for each property remaining), which could include direct and/or indirect monthly costs. In other words, the system calculates the direct cost (and optionally indirect cost) for each house.

As mentioned above, for users looking for properties to rent, the system 10, in step 56, of the individual property filtering phase 54, the total cost of ownership module 22 calculates monthly direct cash flow and monthly indirect cash flows for each rental property remaining. For example, for renting, monthly direct cost could include monthly rent and fuel costs, and the monthly indirect cost could include vehicle depreciation. The system 10 could calculate a maximum price based on the assumption that all monthly cash flows are going toward rent payment. In step 58, the system 10 filters results based on calculated and indirect cash flows associated with renting the property. In step 60 of the individual property filtering phase 54, the total cost of ownership module 22 calculates total cost of renting for each property remaining.

In step 63 of the individual property filtering phase 54, the school rating filtration module 20 determines the assigned school for each property remaining (e.g., each property having a monthly direct cost less than the monthly cash flow a user is willing or able to make toward a property). The system could use Maponics school boundary data to find the elementary school, intermediate school, and/or high school assigned to each property (e.g., apartment, house). In step 64 of the individual property filtering phase 54, the school rating filtration module 20 filters properties (e.g., eliminates properties) based on whether the assigned school for that property matches the school criteria (e.g., school rating criteria). The system 10 could use Great School's ratings to find ratings for each school assigned to each remaining property. Accordingly, properties that do not have a school at or above the school criteria (e.g., school rating criteria) are eliminated.

In step 66 of the individual property filtering phase 54, the commute-based search module 18 calculates actual commute time(s) for each property remaining. The system 10 could use a Google API Call to electronically obtain the actual walking time, biking time, driving time, transit time, and/or distance, etc. for one or more users (e.g., husband, wife, child, etc.) between the user's work location(s) and the subject property, from a third-party distance calculation service provided by google, Inc. or other suitable provider. In step 67 of the individual property filtering phase 54, the commute-based search module 18 filters properties based on whether the actual commute time(s) meet the commute criteria. If the property does not meet the commute requirements (e.g., commute time is too long), then the property is removed.

In step 70, the scoring module 68 calculates one or more financial scores based on financial components (e.g., price, direct costs, indirect costs, etc.) for each property remaining. Additionally, the system could calculate a combined financial score which incorporates and weights different types of financial scores into one combined financial score. For example, the scoring module could calculate a property score which measures how much house or apartment a user gets for every dollar spent in monthly costs. The property score for home buyers could be represented as:

Property Score=(Property Price−Down Payment)/Total Monthly Cost of Ownership Equation 1

The total monthly cost of ownership could be monthly direct costs plus monthly indirect costs. To calculate the property score for the current residency of the user, the system 10 could request the user(s) work location, home address, type of house, amount paid in property taxes, amount paid in property insurance, down payment the user could afford if house is sold, loan term of new mortgage, etc. Then the system 10 could calculate the monthly direct cost, which could include the bank installment for the loan (e.g., home price−down payment), property taxes, PMI (if down payment is less than 20%), property insurance, association fee (if applicable), fuel cost of commute (e.g., calculated from commute driving distance). The system 10 could also calculate the monthly indirect costs including property maintenance (e.g., based on home price), vehicle depreciation (e.g., based on commute distance), tax benefits (e.g., credit based on property taxes and interest paid). The property score for renters could be represented as:

Property Score=(Bdrms+Bthrms)/(MDRC+MIRC) Equation 2

Where Bdrms is the number of bedrooms, Bthrms is the number of bathrooms, MDRC is the monthly direct rent cost, and MIRC is the monthly indirect rent cost, similar to that described above.

In step 72, the scoring module 68 calculates one or more non-financial scores (e.g., commute score, school score, safety score, etc.) for each property remaining. For example, the commute score is based on which of the one or more users would spend the most time commuting (e.g., husband, wife, child, roommate). The commute score could be calculated based on the actual commute time (e.g., the maximum commute time among one or more users), such as based on ranges of commute time (e.g., less than 20 minutes, 20-30 minutes, 30-45 minutes, 45-60 minutes, more than 60 minutes, etc.). As another example, the school score could be a weighted calculation based on the rankings for each type of school (e.g., elementary school, middle school, high school) assigned to a particular property. Additionally, the system could calculate a combined non-financial score (e.g., life quality score) which incorporates and weights different types of non-financial scores (e.g., commute score, school score, safety score, etc.) into one combined non-financial score.

In step 73, the scoring module 68 optionally calculates one or more scores (e.g., financial score, non-financial score, combined financial score, combined non-financial score, etc.) for the current residency of the user for comparison with residencies with better scores (and/or for filtering residencies with worse scores). The scoring module 68 could remove properties that do not have a better score (e.g., property score, commute score, etc.) than a user's current residency.

In step 74, the scoring module 68 could calculate a final score (e.g., property quality score) which combines (e.g., weights) the one or more financial scores and the one or more non-financial scores together into one score.

In step 75, the system 10 sorts results by one or more calculated scores (e.g., final score, combined financial score, combined non-financial score, property score, commute score, etc.). In step 76, the system 10 electronically displays the results (e.g., Listing Page) to a user (e.g., electronically transmits the results to the end user computing device). For example, the system 10 could display the properties (e.g., houses) with the highest property score at the top, which could be the property that meets all search criteria (e.g., commute criteria, school criteria, safety criteria, financial parameters, etc.) and has the least amount of percentage wasteful spending going towards taxes, rent, and/or fuel (e.g., compared to total monthly costs).

It is noted that the steps depicted in FIG. 2 do not have to be performed in the order illustrated, and could be performed in a different order. For example, the steps of the school rating filtration module 18 of the optimization filtering phase 36 could be executed before the steps of the commute-based search module 18 of the property location filtering phase 36.

The process above is described as receiving data iteratively from the user, where the search criteria data is received at particular steps throughout the process and/or incorporated into the search in real time. This allows the system 10 to update search results (e.g., in real time) as to how many houses match the user's search criteria (e.g., “There are <houseCountList1> houses which match your commute criteria. Let us further filter these based on school criteria”) or if the search data is too restrictive to provide any results (e.g., “There are no houses which match your commute criteria. Please revise your search parameters.”). Alternatively, the system 10 could request all search criteria data (e.g., commute preference/criteria data, school preference/criteria data, safety preference/criteria data, cost preference/criteria data, etc.) from an end user computing device (e.g., user computer system) before beginning the optimization filtering phase 36.

Further, as described above, the optimization filter includes a first layer (e.g., commute filter layer), a second layer (e.g., school filter layer), a third layer (e.g., safety filter layer), and a fourth layer (e.g., property price layer). However, other types of layers could be used instead of or in addition to those described above.

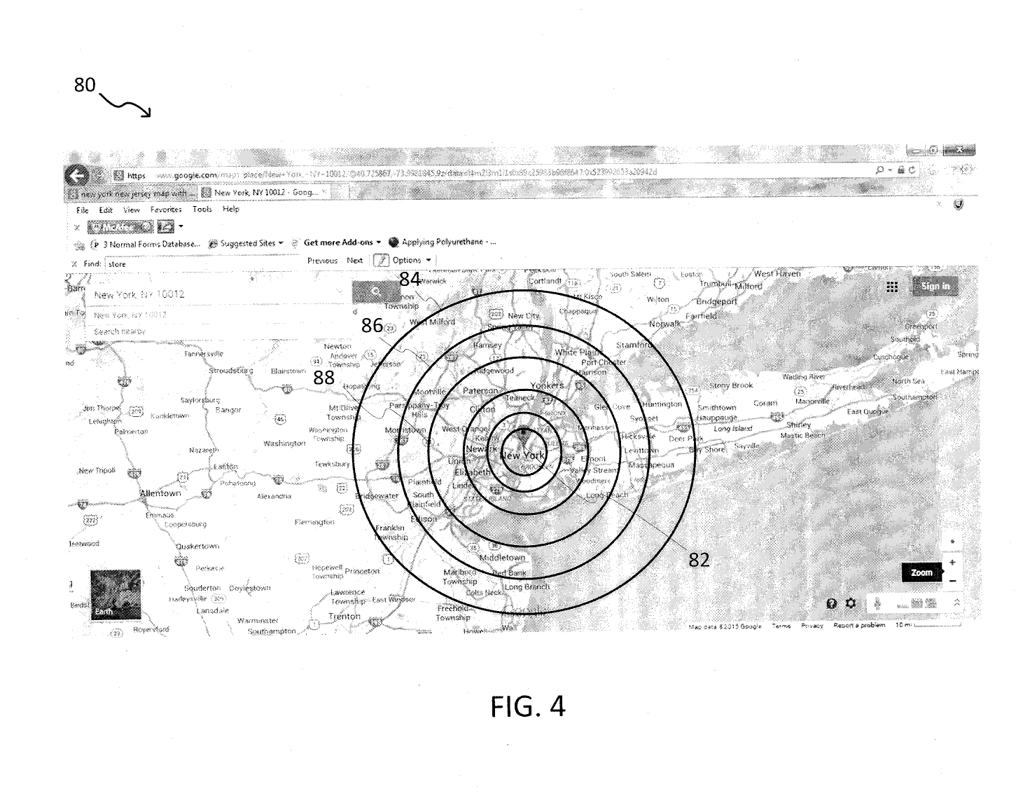

FIG. 4 is a screenshot 80 illustrating filtering by commute criteria in the property location filtering phase, as discussed in steps 38-42 of FIG. 2. More specifically, the screenshot 80 shows a work address 82. Commuting distance rings 84, 86, 88 represent the various straight line distances from that work address based on commute criteria electronically received from the end user computing device. The electronic commute criteria could include a work address, a maximum commute time (e.g., 45 minutes), a maximum commute distance (e.g., 20 miles), and/or a preferred method of transportation (e.g., walking, bus, rail, and/or car). For example, a user could indicate a work address 82 as downtown Manhattan, N.Y. 10012, as well as indicate a maximum commute time as 45 minutes, a maximum commute distance as 20 miles, and/or a preferred method of transportation as by car. As discussed below, the system then finds all the zip codes which fall within the straight line radius (e.g., 40 mile radius 84, 35 mile radius 86, 30 mile radius 84, etc.) of zip code 10012 consistent with the commute criteria received. Importantly, querying the optimization database for all zip codes which fall within a straight line radius of the work location indicated, optimizes the search thereby improving computational efficiency, search time, etc.

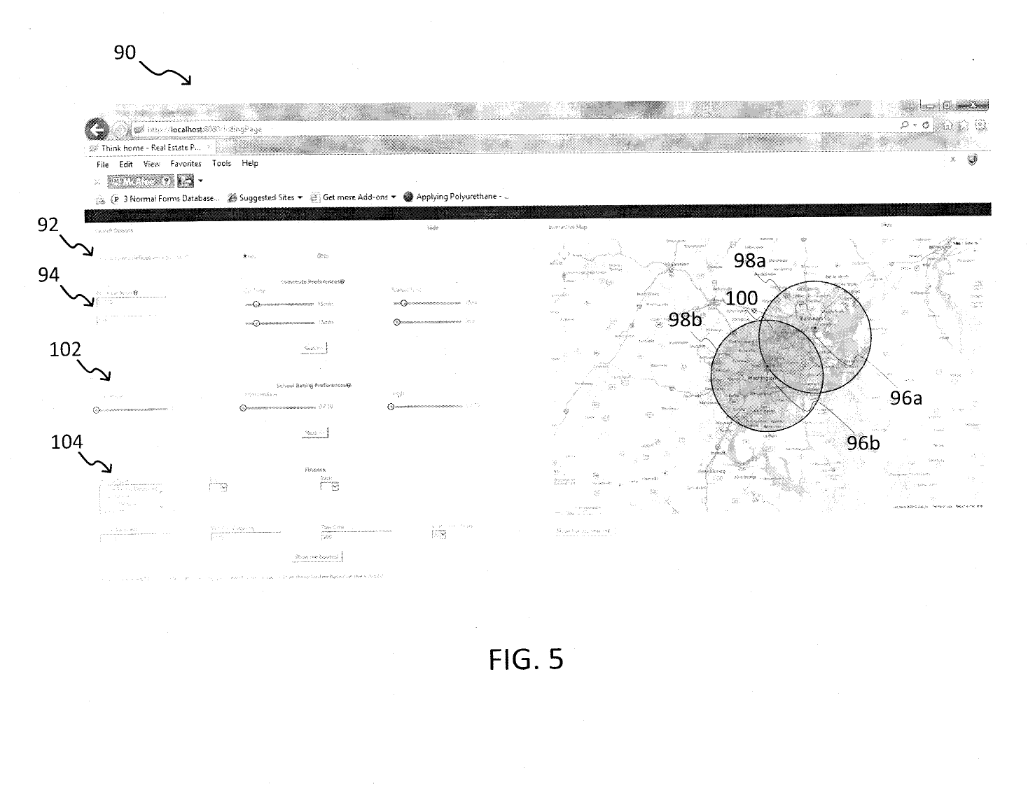

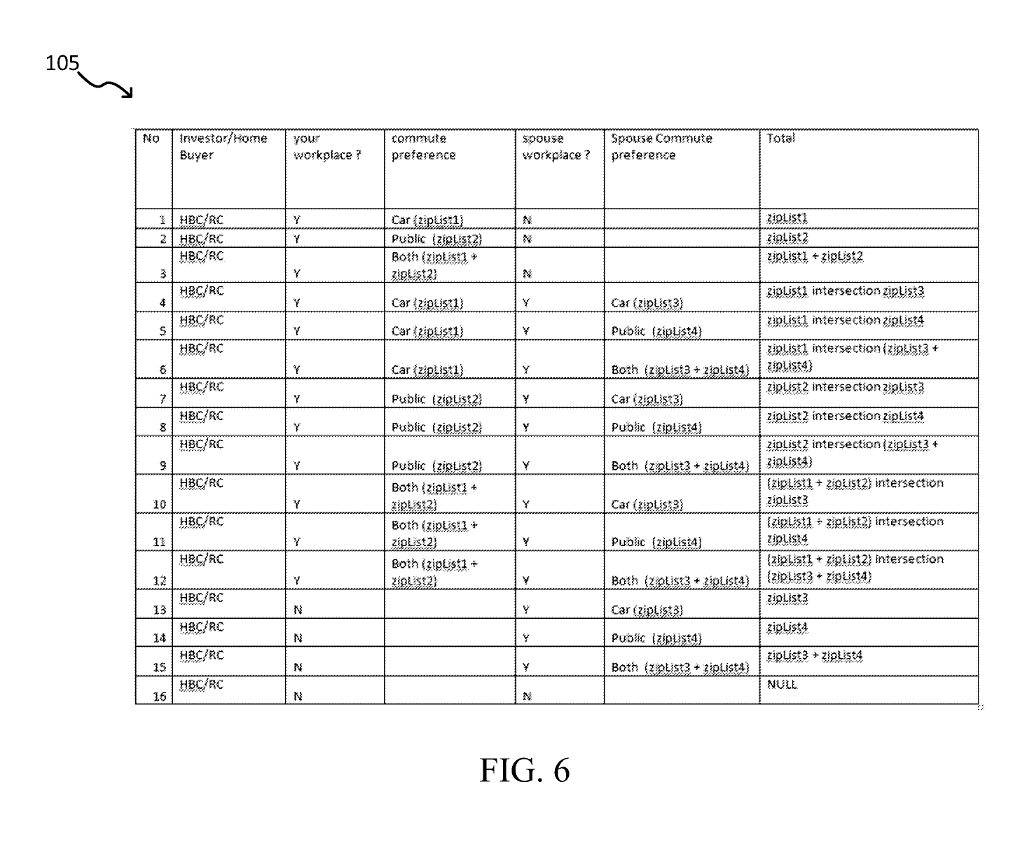

FIGS. 5-6 illustrate filtering by commute criteria. More specifically, FIG. 5 is a screenshot 90 illustrating a user interface generated by the system for allowing a user to specify search criteria, as well as filtering by commute criteria for multiple users, as discussed in steps 35-42 of FIG. 2. The screenshot 90 illustrates an electronic request for commute criteria, which includes, for example, whether the user has a defined work location 92 (e.g., radio button) and if so the commute preferences 94 of one or more users. The commute preferences 94 could electronically request the user to define the work location (e.g., by zip code, by address, etc.), the maximum allowed car time (e.g., 10 minutes, 15 minutes, 30 minutes, etc.), and/or the maximum total transit time (e.g., 10 minutes, 15 minutes, 30 minutes, etc.), where the total transit time could include time spent walking, biking, driving (e.g., by car), taking public transportation (e.g., bus, train, etc.), etc.

The commute preferences 94 could be received for one or more users, which could be electronically displayed on a digital map 95. For example, the system could electronically receive commute preferences 94 of a first user and commute preferences 94 of a second user and filter out results that do not overlap (e.g., meet the commute preferences of both users). The system could then display (e.g., plot) in the digital map 95 the first user work location 96a and the first commute radius 98a (e.g., based on maximum allowed car time, maximum transit time, etc.), the second user work location 96a and the second commute radius 98b (e.g., based on maximum allowed car time, maximum transit time, etc.), and the area overlap 100 of the first commute radius 98a and second commute radius 98b (e.g., the area which meets the commute preferences 94 of the first user and the second user).

The system processes the data electronically received to find the zip codes which match the commute criteria of the multiple users, such as by using the following inputs:

getZipCodeList1ForCommuter(‘H/I/R’, ‘Y/N’,Z1, T1, T2, ‘Y/N’,Z2, T3, T4)

getZipCodeList1ForWorkLocation (parm1, parm2, parm3, parm4, parm5, parm6, parm7, parm8, parm9)

parm1=H/R (Home Buyer/Renter)

parm2=Y/N based on user has defined work location or not

parm3=Z1, which is zip code of user's work location

parm4=T1 which is the time user is ready to spend in driving

parm5=T2 which is the time user is ready to spend in public transit

parm6=Y/N based on second user has defined work location

parm7=Z2, which is zip code of second user's work location

parm8=T3 which is the time second user is ready to spend in driving

parm9=T4 which is the time second user is ready to spend in public transit

The systems then runs the following queries on the search optimization database 14 of FIG. 1:

Select zipCodeInDrivingRange as zipList1 from ZipDrivingDurationTb WITH(NOLOCK) where zipCode=Z1 and drivingDuration=T1

Select zipCodelnTransitRange as zipList2 from ZipTransitDurationTb WITH(NOLOCK) where zipCode=Z1 and transitDuration=T2

Select zipCodelnDrivingRange as zipList3 from ZipDrivingDurationTb WITH(NOLOCK) where zipCode=Z2 and drivingDuration=T3

Select zipCodelnTransitRange as zipList4 from ZipTransitDurationTb WITH(NOLOCK) where zipCode=Z2 and transitDuration=T4

The system then creates the following decision tree based on ‘H/I/R’, ‘Y/N’,Z1, T1, T2, ‘Y/N’,Z2, T3, and T4:

If parm2 is Y: Always add zipList1 and zipList2 to produce resultSet1 (e.g., getZipCodeList1ForCommuter(‘H/I/R’, ‘YIN’, Z1, T1, T2, ‘YIN’, Z2, T3, T4))
If parm6 is Y: Always add zipList3 and zipList4 to produce resultSet2 (e.g., getZipCodeList2ForSchool(zipCodeList1, E, M, H))
If both parm2 and parm6 are ‘Y’, then take the common elements of resultSet1 and resultSet2 to produce zipCodeList1
If parm2 is ‘Y’, but parm6 is ‘N’, take zipCodeList1=resultSet1 (e.g., getZipCodeList1ForNonCommuter(Z1, D1))
If parm2 is ‘N’, but parm6 is ‘Y’, take zipCodeList1=resultSet2 (e.g., getZipCodeList1ForNonCommuter(Z1, D1))

The table 105 of FIG. 6 illustrates logic according to the system for creating a zip code list table (i.e., “zipCodeList1” the table referenced above). The output of such logic is a list of zip codes matching commute criteria (e.g., zipCodeList1), and total number of houses for sale within those zip codes (e.g., houseCountList1).

Referring back to FIG. 5, the screenshot 90 further illustrates an electronic request for school preferences 102, if any. For example, the system could electronically receive school preferences 102 (e.g., by a slider) that include a minimum school rating for elementary school, intermediate school (e.g., middle school), and/or high school.

The screenshot also illustrates an electronic request for finance preferences 104, if any. For example, the system could electronically receive finance preferences 104 that include a house type (e.g., single family detached, townhouse, condominium, apartment, etc.), a minimum number of bedrooms (e.g., 1, 2, 3), a minimum number of baths (e.g., 1, 2, 3), down payment (e.g., $40,000), monthly outgoing expenses (e.g., $1,700), monthly fuel cost (e.g., $300), and loan term (e.g., 30 years).

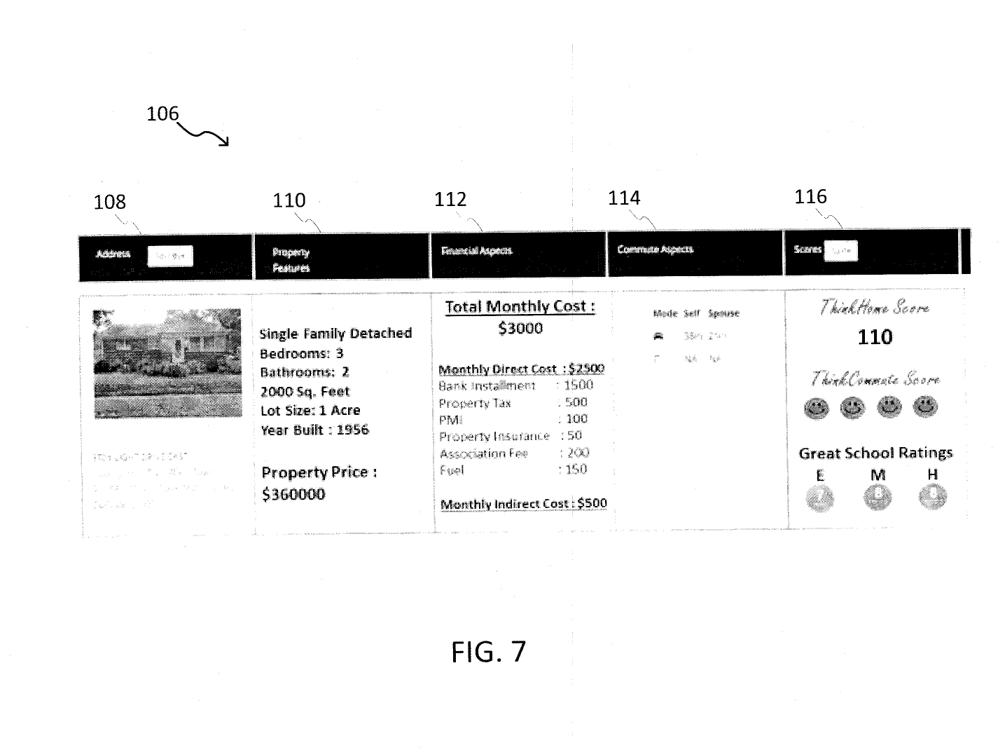

FIG. 7 is a screenshot 106 illustrating results of property searching generated by the system of the present disclosure. More specifically, the first results view 106 includes an address section 108, a property features section 110, a financial aspects section 112, a commute aspects section 114, and a scores section 116. The address section 108 could include an address of the property and a picture of the property (if available). The property features section 110 could include the type of property (e.g., single family detached), number of bedrooms, number of bathrooms, square footage, lot size, year built, and/or property price (e.g., to own, to rent).

The financial aspects section 112 could include the total monthly cost (e.g., to own, to rent), monthly direct costs and breakdown thereof (e.g., bank installment cost, property tax cost, private mortgage insurance (PMI) cost, property insurance cost, association fee, fuel, etc.), and/or monthly indirect costs. The commute aspects section 114 could include the mode of transportation (e.g., car, walking, etc.) and the length of the commute for each user indicated (e.g., 38 minutes of commute by car for a first user, 21 minutes commute by car for a second user). The scores section could include the property score, the commute score, and the school ratings score for the elementary school, middle school, and/or high school associated with the property. As described above, the property score (e.g., ThinkHome Score) measures the building of equity per dollar spent on total monthly costs, the commute score (e.g., ThinkCommute Score) measures how short of a commute the user with the longest commute would have, and the school ratings score (e.g., Great School Ratings) is an overall measure of the quality of the school associated with the particular property returned by the search.

The first results view 106 could include additional information and/or links to information related to how the commute score and/or property score is calculated, how commute affects overall happiness, school ratings for a particular school district, commute cost, maintenance cost, tax bracket, etc. The additional information and/or links shown can vary depending on the search criteria electronically received by the computer system by the user.

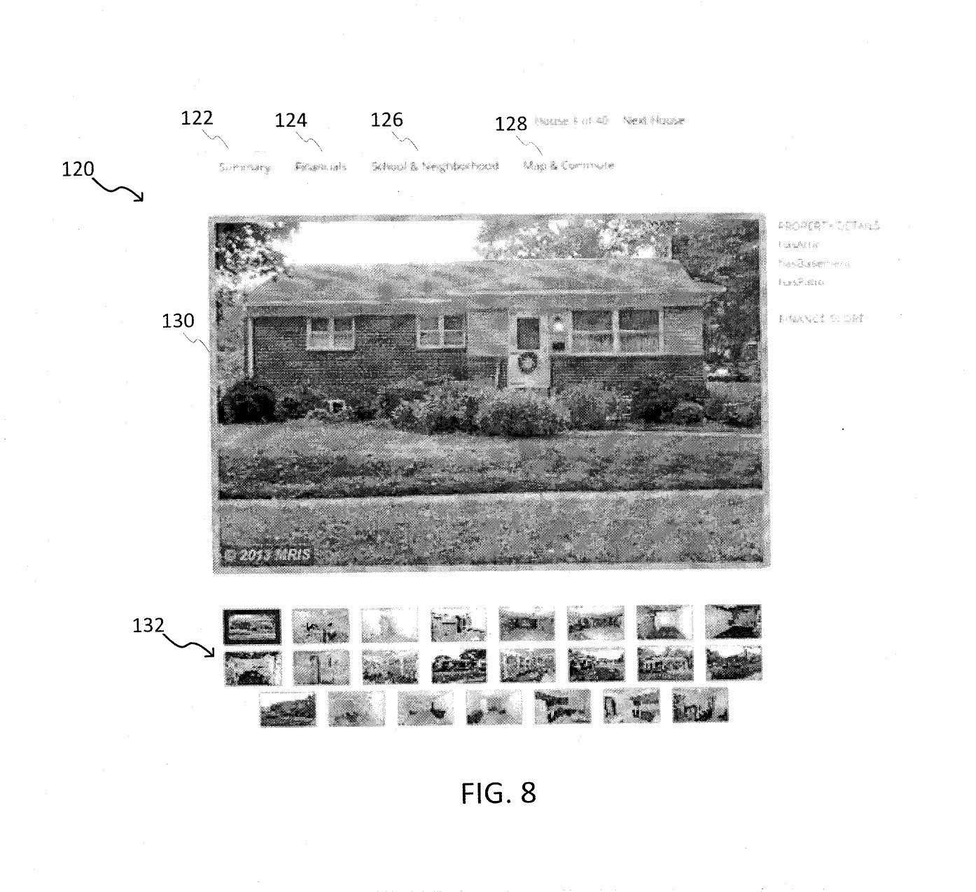

FIG. 8 is a screenshot 120 illustrating additional information relating to property searches generated by the system of the present disclosure. More specifically, the second results view 120 could include a plurality of tabs such as a summary tab 122, a financials tab 124, a school and neighborhood tab 126, and/or a map and commute tab 128. As shown, the summary tab 122 could include a main picture section 130, as well as a thumbnail picture section 132 showing one or more reduced pictures of the property (e.g., of the front yard, the back yard, the rooms inside, etc.), where the main picture section 130 displays an enlarged picture of the property selected in the thumbnail picture section 132.

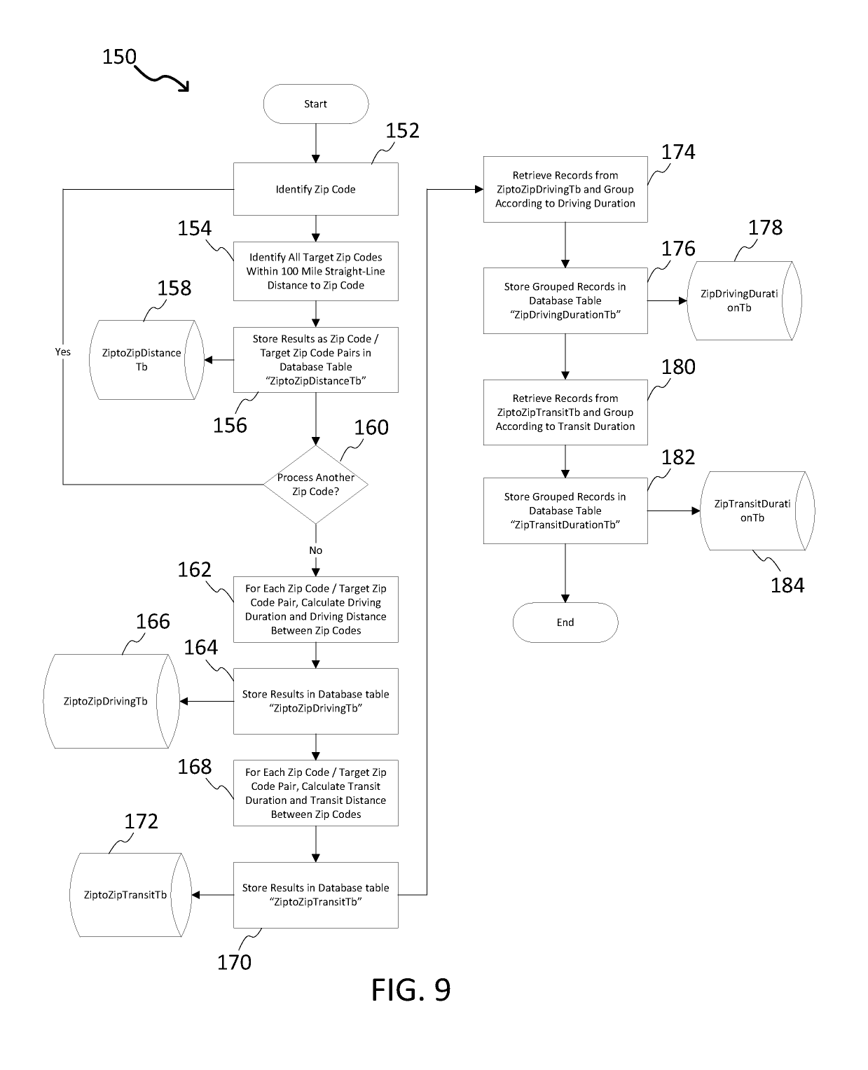

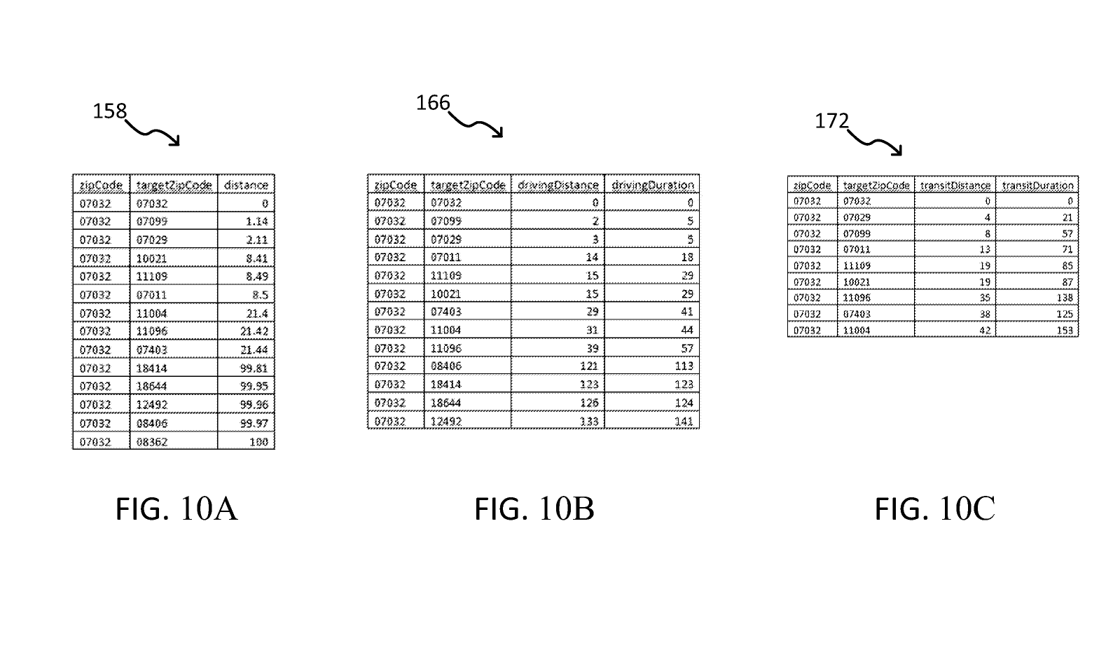

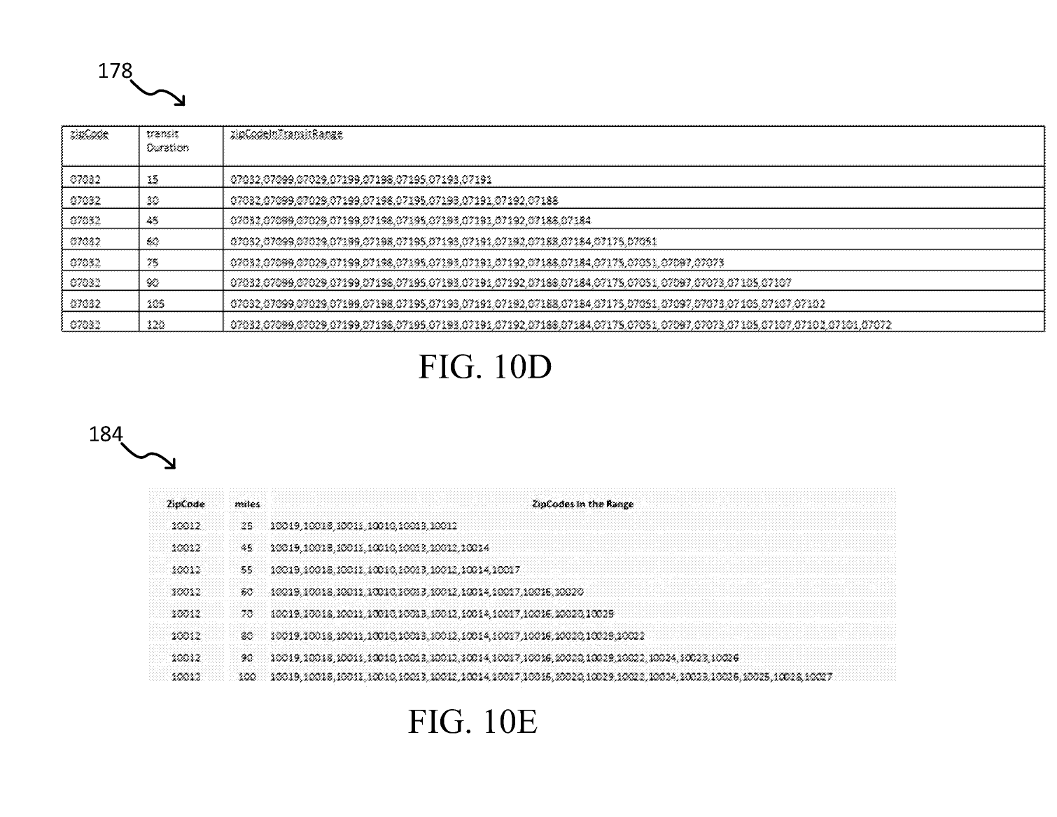

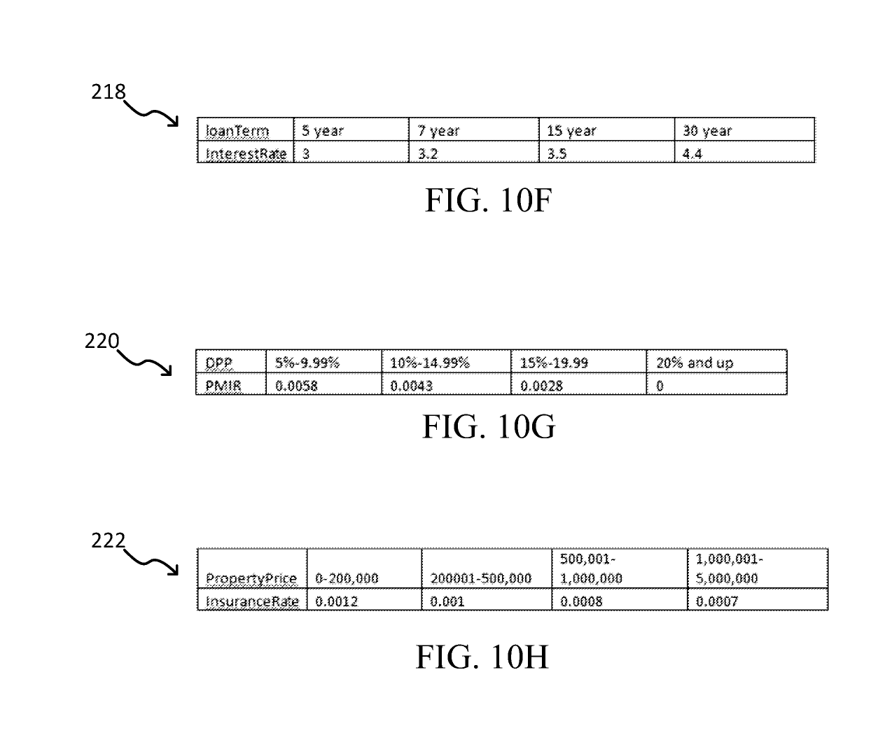

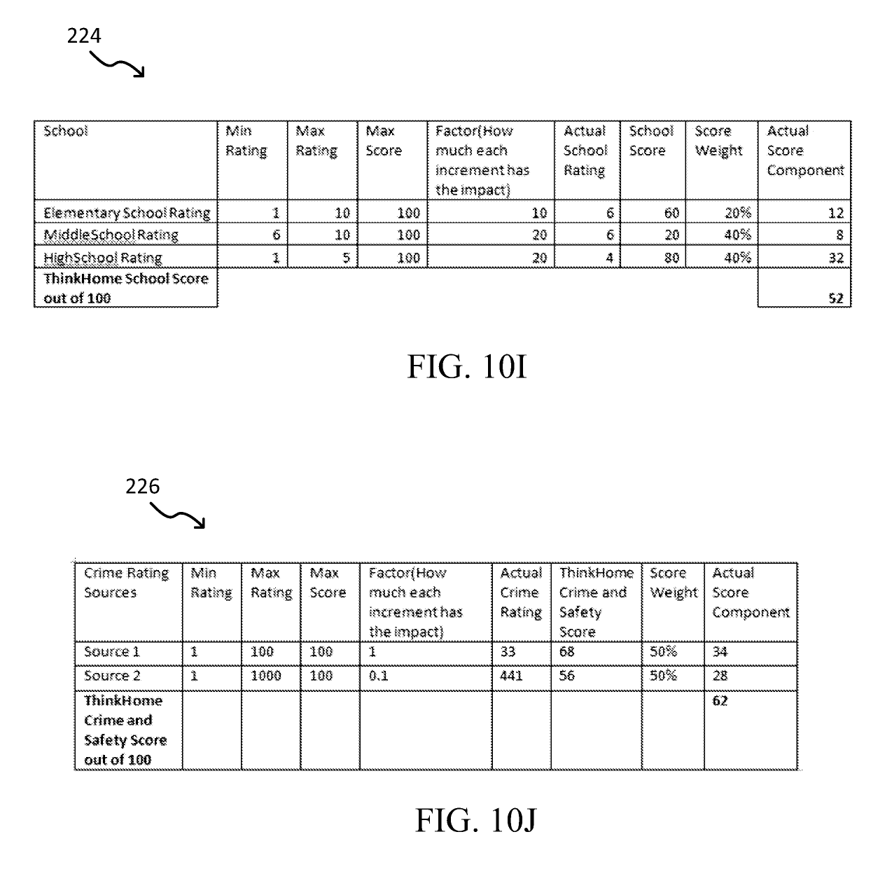

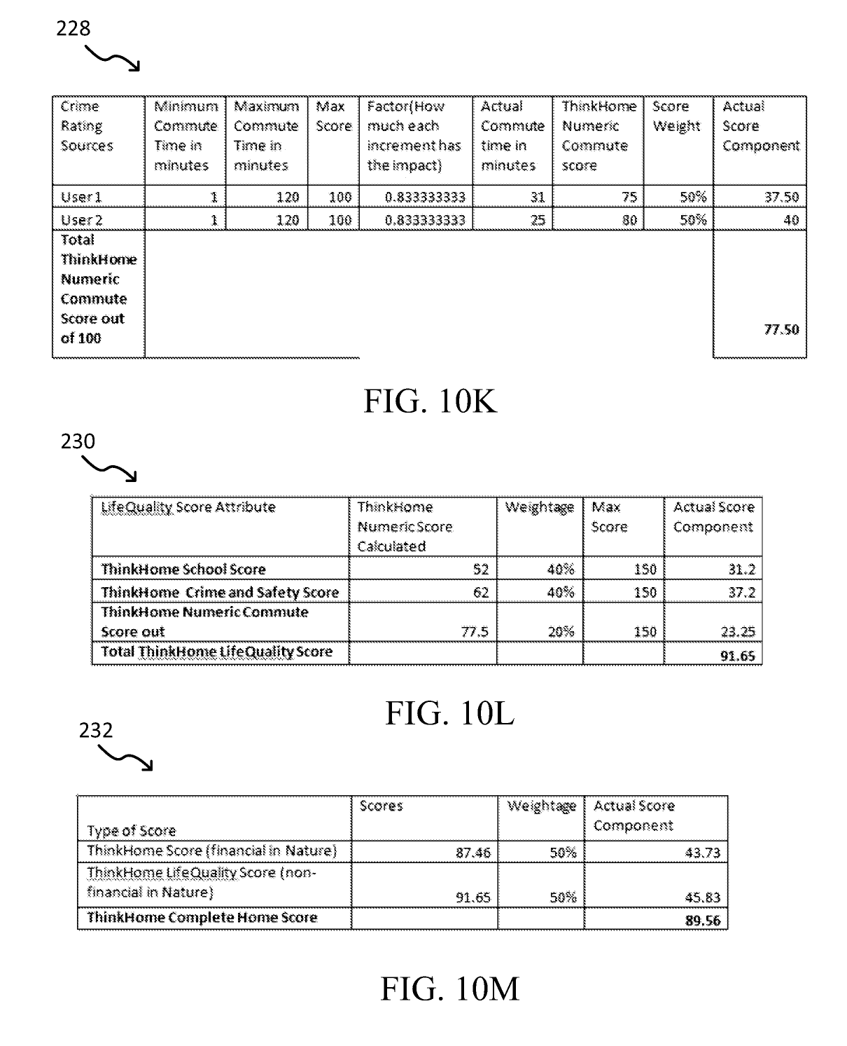

FIGS. 9-10E illustrate creation of a search optimization filter of the present disclosure. More specifically, FIG. 9 is a flowchart showing overall processing steps 150 for creating a search optimization filter. Importantly, the search optimization filter is provided as a plurality of pre-programmed database tables stored in the optimization database 14 of FIG. 1. Whenever a property search is conducted, the system queries these tables to rapidly identify only specific properties within a desired physical distance from the user's work location. The system electronically requests the location of the user's workplace and the amount of time the user is willing to commute. As discussed above, the optimization filter reduces the amount of potential properties to evaluate. Accordingly, the system uses the search optimization filter to find zip codes within the user's commute time, and to eliminate those zip codes that are not within the user's commute time. The optimization filter comprises a search optimization database which includes all U.S. zip codes (e.g., about 40,000 zip codes) and for each of those zip codes all other zip codes that are within a pre-defined distance therefrom (e.g., 100 miles, 50 miles, and/or 30 miles, etc.). This reduces the number of computations and the processing time, resulting in faster, less computationally intensive, high-quality searches, thereby improving computer performance.

To create the optimization filter, in step 152 the system identifies a zip code. In step 154, the system identifies all target zip codes within 100 mile (e.g., or any other distance(s)) straight line distance to the zip code. In step 156, the system stores the results as zip code/target zip code pairs in database table ZiptoZipDistanceTb 158 (although any database table name could be used). FIG. 10A illustrates an example ZiptoZipDistanceTb 158.

In step 160, the system determines whether there is another zip code to process. If so, the process reverts to step 152. If not, the process proceeds to step 162. In this way, the process repeats for each zip code so that the system finds the all 100 mile straight line distance target zip codes for each zip code (e.g., around 1.76 billion combinations), which results in a comprehensive table (e.g., 33 million records in the table).

In step 162, for each zip code/target zip code pair, the system calculates the driving duration and driving distance between the zip codes. This evaluates each zip code/target zip code pair in the ZiptoZipDistanceTb 158 to calculate the driving duration and driving distance between the two zip codes. In step 164, the system stores the results in database table ZiptoZipDrivingTb 166 (although any database table name could be used). FIG. 10B illustrates an example ZiptoZipDrivingTb 166.

In step 168, for each zip code/target zip code pair, the system calculates transit duration and transit distance between zip codes. This calculates the actual transit duration and transit distance between each zip code/target zip code pair in the ZiptoZipDtanceTb 158. In step 170, the system stores results in database table ZiptoZipTransitTb 172 (although any database table name could be used). FIG. 10C illustrates an example ZiptoZipTransitTb 172.

In step 174, the system electronically retrieves records from ZiptoZipDrivingTb 166 and groups those records according to driving duration. This takes data from ZiptoZipDrivingTb and groups all the target zip codes which fall under pre-determined driving durations (e.g., 15, minutes, 30 minutes, and/or 45 minutes, etc.) from the zip code. In step 176, the system electronically stores the grouped records in database table ZipDrivingDurationTb 178 (although any database table name could be used). FIG. 10D illustrates an example ZipDrivingDurationTb 178.

In step 180, the system electronically retrieves records from ZiptoZipTransitTb 172 and groups according to transit duration. This takes data from ZiptoZipTransitTb and groups all target zip codes falling under certain transit durations (e.g., 15, minutes, 30 minutes, and/or 45 minutes, etc.) from the zip code. In step 182, the system electronically stores the grouped records in database table ZipTransitDurationTb 184 (although any database table name could be used). FIG. 10E illustrates an example ZipTransitDurationTb 184.

The optimization filter comprises the ZipDrivingDurationTb 178 of FIG. 10D and the ZipTransitDurationTb 184 of FIG. 10E to optimize searches and reduce computation time and resources. The alternative of the optimization filter would be to evaluate each house in the listing (e.g., around 4 million houses available for sale) from around 40,000 zip codes and calculate if the house meets a user's search criteria, which could require far more time and computation resources. Comparatively, using the optimization filter requires evaluation of an average of about 117 zip codes for search within 40 minutes of driving time from a user's work location, which is under 0.3% of the total number of zip codes. Even for search within 120 minutes of a driving time from a user's work location, the optimization filter results in the system only having to evaluate 750 zip codes, which is still under 2% of the total number of zip codes. Further, by using the optimization filter (e.g., pre-built tables), the system has to evaluate less than 0.5% of total zip codes for a search within 120 minutes of transit time from a user's work location.

It is noted that the driving duration and transit duration of the optimization filter are only the first level of filtering. As explained above, the system also finds the actual driving time and/or transit time between the work location and each property location (e.g., using Google API calls), eliminating the properties not meeting the search criteria. Because of the optimization filter, the number of properties requiring this level of evaluation are significantly reduced, thereby ensuring a reasonable time for the search results (e.g., 2-5 seconds).

Further, the system has evaluated each zip code/target zip code pair in ZiptoZip DistanceTb 158 to create similar tables for waking distance (e.g., ZiptoZipWalktb), walking duration (e.g., ZipToZipWalkDurationTb), biking distance (e.g., ZipToZipBikeTb), and/or biking duration (e.g., ZipToZipBikeDurationTb).

FIGS. 10E-10H are tables used to calculate the maximum affordable property price of a user, the total monthly cost of ownership of a user, and the property score. Below is a description and example of the system calculating the maximum property price. The system electronically receives financial and/or property related parameters from an end user computing device (e.g., typeOfHouse, beds, baths, DP (down payment), cashFlow1 (for house cost), cashFlow2 (for commuting fuel cost), loanTerm, etc.). The system then calculates the monthly payoff amount for $100,000 using the table 218 in FIG. 10F, which provides interest rates for different types of loan terms. The contents (e.g., values) of table 218 could be updated daily (e.g., based on interest rates published by lenders) or as otherwise needed. The data in the table 218 of FIG. 10F could be updated daily (e.g., from national mortgage lenders).

From the table 218 of FIG. 10F, the system obtains the IR (interest rate) based on the loan term. The monthly payoff amount could be calculated using the following equation:

$$A = P \cdot \frac{{r ( 1 + r )}^{n}}{{( 1 + r )}^{n} - 1} \qquad Equation 3$$

Where A=EMIPER100K (EMI per $100,000), P=100000, n=loanTerm*12, r=IR/1200. For example, from the table of FIG. 10F, for a 30 year loan term r=4.4/1200=0.003667, and n=30*12=360, such that A=100000*[(0.003667*(1+0.003667)̂360)/((1+0.003667)̂360)−1)]=$500.76.

A first maximum property price (e.g., down payment maximum price) is calculated based on the down payment, such that:

PP1=DP/(MinDp) Equation 4

where PP1 is the first maximum property price, DP is the down payment, and MinDP is the minimum required down payment. Continuing with the example, PP1=40K/0.05=800K.

A second maximum property price (cash flow maximum price) is calculated based on cash flow, such that:

PP2=CF*100000/EMIPER100K+DP Equation 5

where PP2 is the second maximum property price, CF is cash flow (e.g., main cash flow plus fuel cost), EMIPER100K is EMI per $100,000, and DP is the down payment. This represents how much a user can borrow and then adds down payment to arrive at a second maximum property price. The cash flow is represented by:

CF=cashFlow1+cashFlow2 Equation 6

The system assumes that all monthly cash flow is going towards mortgage payment (e.g., principle plus interest). Continuing with the example, assume that CF=1,700+300=2,000, then PP2=2,000*100,000/500+40,000=440,000.

The system then calculates a third maximum property price by taking the lesser of the first maximum property price and the second maximum property price, such as represented by:

PP3=MIN(PP1,PP2) Equation 7

Continuing with the example, PP3=Min(800,000, 440,000)=440,000. However, the system further incorporates into the maximum property price other financial parameters, such as property tax, PMI, and property insurance.

Effect of property tax on monthly cash flow can be represented by:

CF1=PP3*(propertyTaxApprox)/12 Equation 8

Continuing the example, assuming the property tax (propertyTaxApprox) is at least 1%, CFP=440,000*0.01/12=366.66.

To calculate the effect of PMI on the monthly cash flow, the system first calculates the down payment as a percentage (DPP) of the third maximum property price, such that:

DPP=DP*100/PP3 Equation 9

Continuing with the example, then DPP=40,000*100/440,000=9.09%. The system then obtains the approximate PMI rate based on down payment percentage (PMIR) from the table 220 in FIG. 10G. Continuing with the example, if DPP is 9.09%, then PMIR is 0.58%. The effect of PMI on cash flow per month could be represented by:

CF2=(PP3−DP)*PMIR/12 Equation 10

Continuing with the example, CF2=400,000*0.0058/12=193.33. Accordingly, for property worth $440,000 with a down payment of $40,000, PMI cost per month is $193.33.

To calculate the effect of property insurance (e.g., property/hazard insurance payment) on monthly cash flow, the system maintains the property insurance table 222 in FIG. 10H, which gives approximate insurance rates based on property price. The monthly cash flow effect of property insurance could be represented by:

CF3=PP3*InsRate/12 Equation 11

Continuing with the example, if the insurance rate is 0.001, then CF3=440,000*0.001/12=$36.66. Accordingly, for property worth $440,000, property insurance cost per month is $36.66.

Final monthly cash flow available towards loan payment can be represented by:

FCF=CF−(CF1+CF2+CF3) Equation 12

Continuing with our example, FCF=2000−(366.66+193.33+36.66)=$1403.33. As a result of this reduced cash flow, the fourth maximum property price could be represented by:

PP4=FCF*100000/EMIPER100K+down-payment Equation 13

Continuing with the example, PP4=1403.33*100000/500+40,000=$320,666. The final maximum property price could be represented by:

FPP=MIN(PP3,PP4) Equation 14

Continuing with the example, FPP=Min(440K, $320,666)=$320,666.

The system then electronically retrieves a list of houses consistent with the search criteria (e.g., type of house, number of beds, number of baths) from Multiple Listing Service (MLS) or a local or remote database storing MLS data (e.g., where the database could be periodically updated with MLS information), the remaining zip codes (e.g., zipCodeList3), and/or with the final maximum property price (e.g., $320,666).

Below is a description and example of the system calculating the total monthly cost of ownership and the property score. The system electronically receives financial and/or property related parameters from an end user computing device (e.g., typeOfHouse, beds, baths, DP (down payment), cashFlow1 (for house), cashFlow2 (for commuting fuel cost), loanTerm, etc.). Continuing the example discussed above, assume that DP=$40,000, listingPrice=$240,000, cashFlow1=$1700, cashFlow2=300, CF=cashFlow1+cashFlow2=$2000, loanTerm=30 years, interest rate=4.4, EMI per 100K=$500, and house listing price=$240,000.

The system calculates a monthly direct cost based on bank installment payment, property tax, and PMI. The monthly bank installment cash flow could be represented by:

OCF1=((listingPrice−DP)*EMIPER100K)/100000 Equation 15

Where OCF1 is the outgoing CashFlow1, (listingPrice−DP) is the L mean Loan or Money Borrowed. Continuing the example, the OCF1=($240,000−$40,000)*500/100000=$1000.

The monthly property tax cash flow could be represented by:

OCF2=Tax/12 Equation 16

Where the system obtains the property tax from MLS. Continuing the example, OFC2=$4,800/12=$400. The monthly PMI cash flow could be represented by:

OCF3=L*PMIR/12 Equation 17

Where the percent PMI could be based on down payment percent and taken from the table 220 of FIG. 10G. The contents (e.g., values) of table 220 could be updated daily or as otherwise needed. The down payment percent could be represented by:

DPP(Down Payment Percent)=DP/listingPrice Equation 18

As a result, the PMI rate (PMIR) varies depending on the down payment percent. For example, if DPP>=0.05 and DPP<0.1 then the PMIR is 0.58, if DPP>=0.1 and <0.15 then the PMIR is 0.43, if DPP>=0.15 and <0.2 then the PMIR is 0.27, if DPP>=0.2 then the PMIR is 0, and if DPP<0.05 then the system eliminates the listing. Continuing the example, the DPP=40/240=0.1666, so that the PMIR=0.27. Accordingly, PMI=200,000*0.0028/12=$45.

The system calculates pre-calculated insurance value, which could be represented by:

OCF4=InsuranceRate*listingPrice/12 Equation 19

The system could obtain property insurance rate from the property insurance rate table 222 of

FIG. 10H. The contents (e.g., values) of table 222 could be updated daily (e.g., based on interest rates published by lenders) or as otherwise needed. Continuing the example, OCF4=0.001*240K/12=$20. The system incorporates any monthly association fee (which for this example is $245 per month)

The system then calculates the monthly fuel cost, which utilizes the total miles commute per month (e.g., 40% of IRS value/mile), and can be represented by:

OCF6=(D1+D2)*days traveled per month*percentIRS*@IRSPerMile*travels per day Equation 20

Where D1 is the commuting distance for a first user and D2 is the commuting distance for a second user, although the system could account for more or fewer users. The system calculates a first distance commuted by a first user (D1) as the distance from the zip code of user's work location (Z1) to zip code of property in calculation (Zd). The system calculates a second distance commuted by a second user (D2) as the distance from the zip code of spouse's worklocation (Z2) to zip code of property in calculation (Zd). Continuing the example, assuming D1 is 15 miles, D2 is 10 miles, 20 days of travel per month, 40% of IRS allowed per mile cost, @IRSPerMile is $0.565/mile, and 2 times travel per day (e.g., to and from work), OCF6=(15+10)*20*0.4*$0.56*2=$224.

Accordingly, the direct monthly cost could be represented by:

Monthly Direct Cost=OCF1+OCF2+OCF3+OCF4+OCF5+OCF6 Equation 21

Continuing the example, the direct monthly cost=$1000+$400+$45+$20+$245+$224=$1934. If the direct monthly cost is greater than the user cash flow, the system eliminates the listing. Accordingly, for the example, the Direct Monthly Cash Flow required for the house ($1934) is less than the cash-flow user is willing to spend ($2000), so the house is not eliminated.

The monthly indirect cost could include property maintenance, vehicle depreciation, tax benefits, etc. More specifically, property maintenance could be based on price, age, and condition of property and could be represented as:

ICF1=maintenance*listingPrice, Equation 22

Where maintenance could vary depending on the type of residence. For example, for a condo or townhouse maintenance could be 1.25%, for a single family, multi family, or commercial maintenance could be 1.5%, and for land or lots maintenance could be 0. Continuing our example, assume the property is a townhouse, such that ICF1=1.25%*240,000/12=$250.

Vehicle depreciation could be represented as:

ICF2=(D1+D2)*days traveled per month*percentIRS*@IRSPerMile*travels per day Equation 23

Continuing the example, assuming D1 is 15 miles, D2 is 10 miles, 20 days of travel per month, 60% of IRS allowed per mile cost, @IRSPerMile is $0.565/mile, and 2 times travel per day (e.g., to and from work), ICF2=(15+10)*20*0.6*$0.56*2=$336.

Tax benefits is credit received based on property taxes and interested paid during the year and could be represented as:

ICF3=(yearly taxes+IR*(listingPrice−DP))*@assumedTaxBracket/12 Equation 24

Assuming yearly taxes of $4,800, an IR of 4%, a $240,000 litsing price, a $40,000 down payment, and a 20% tax bracket, ICF3=(4800+4%*($240,000−$40,000))*0.2/12)=$213.33.

Accordingly, the indirect monthly cost could be represented by:

Monthly indirect cost=ICF1+ICF2+ICF3 Equation 25

Continuing the example, the indirect monthly cost=$250+$336−$213.33=352.66. The total monthly cost of ownership is the monthly direct cost plus the monthly indirect cost. Continuing the example, the total monthly cost of ownership=1934+352.66=2286.66.

The property score could be represented by:

Property Score=(listingPrice−DP)/Total Monthly Cost Equation 26

Accordingly, continuing the example, the property score=($240,000−$40,000)/2286.66=87.46

FIGS. 10I-10M are tables illustrating calculation of various scores by the search optimization engine. As discussed above, the search optimization engine could calculate financial scores, non-financial scores, and a final score. More specifically, the search optimization engine could calculate a school score based on the ratings of various types of schools (e.g., elementary school, middle school, high school) assigned to a particular property. For example, as shown in table 224 of FIG. 10I, for a particular property each type of school includes a minimum and maximum rating, which could vary between each type of school. Based on the number of steps (e.g., increments) between the minimum and maximum rating, the search optimization engine calculates a factor, where the factor is the impact of each increment in the rating on a scale of 100. For example, in table 224 the elementary school has a minimum rating of 1, a maximum rating of 10, with 10 increments therebetween, such that on a scale of 100 the factor is 10.

Based on the factor calculated, the search optimization engine could calculate a school score for each type of school, where:

School score=(Actual Rating−Minimum Rating+1)*Factor Equation 27

For example, the actual school rating of the elementary school is 6, so that on a scale of 100 with a factor of 10 the score is 60. As another example, the school score for the middle school would be 20 (e.g., (6−6+1)*20=20), and the school score for the high school would be 80 (e.g., (4−1+1)*20). Converting the scores of all of the schools to the same scale provides for a better comparison of the school scores and the ability to calculate an overall school score. The overall school score could weight the scores of certain types of schools higher or lower than others depending on user criteria and/or user preferences (e.g., the user places more emphasis on the quality of the high school than that of the elementary school).

The search optimization engine could electronically retrieve safety data from one or more sources to compute a safety score (e.g., crime score), similar to that described above for the school score. More specifically, as shown in Table 226 of FIG. 10J, the search optimization engine could calculate a safety rating for a particular property. As the minimum and maximum crime rating may vary among different sources, the search optimization engine converts the scores from the different sources to the same scale. Accordingly, the search optimization engine could calculate a safety score for each data source, where:

Safety score=(Actual Rating−Minimum Rating+1)*Factor Equation 28

For example, for the second source shown in table 226, the safety score is 56 (e.g., (1000−441+1)*0.1). An overall safety score could weight certain data sources more than others (e.g., if certain sources are more reliable or accurate than others).

The search optimization engine could electronically retrieve commute data from one or more sources to compute a commute score, similar to that described above for the school score and safety score. More specifically, as illustrated in FIG. 10K, the search optimization engine could calculate a commute rating for each use of a particular property. The search optimization engine converts the scores for the two users (and from the multiple data sources) to the same scale. Accordingly, the search optimization engine could calculate a commute score for each user, where:

Commute score=(Actual Rating−Minimum Rating+1)*Factor Equation 29

For example, for the first user the commute score is 75 (e.g., (120−31+1)*0.83)). An overall commute score could weight certain data sources and/or users more than others.

The search optimization engine could calculate (e.g., weighted average) a combined non-financial score which incorporates the overall school score, the overall safety score, and/or the overall commute score, as illustrated in Table 230 of FIG. 10L. The combined non-financial score could weight the overall school score, the overall safety score, and/or the overall commute score differently from one another, such as according to user criteria and/or use preferences.

The search optimization engine could calculate (e.g., weighted average) a final score (e.g., property quality score) which incorporates the combined financial score and the combined non-financial score, as illustrated in table 232 of FIG. 10M. The final score could weight the combined financial score and the combined non-financial score different from one another, such as according to user criteria and/or user preferences. As described above, the search optimization engine could sort the results by any of the scores calculated (e.g., combined financial score, combined non-financial score, final score, etc.).

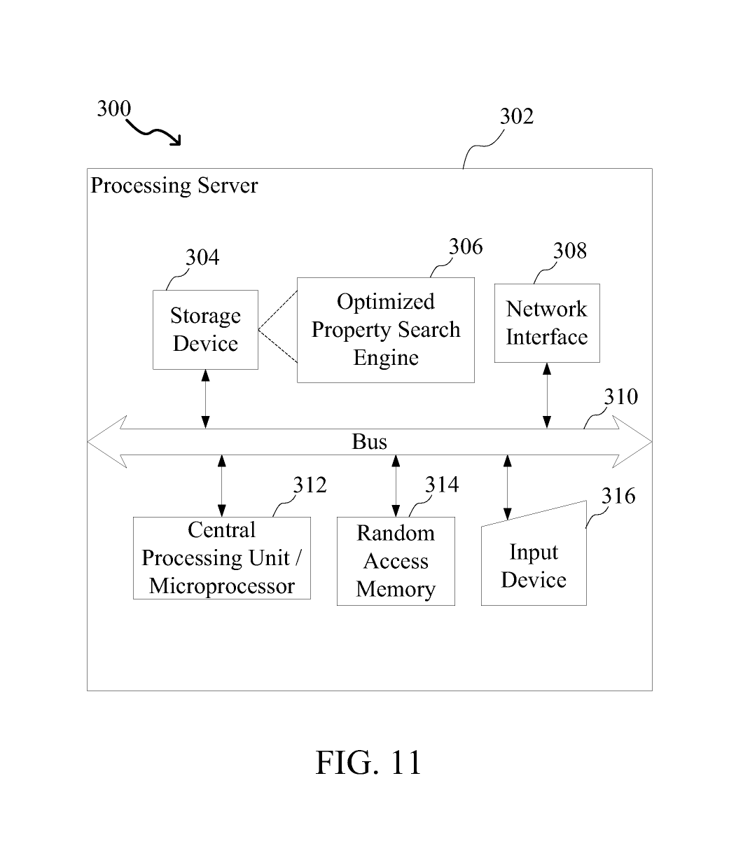

FIG. 11 is a diagram showing hardware and software components of the system 300. The system 300 comprises a processing server 302 which could include a storage device 304, a network interface 308, a communications bus 310, a central processing unit (CPU) (microprocessor) 312, a random access memory (RAM) 314, and one or more input devices 316, such as a keyboard, mouse, etc. The server 302 could also include a display (e.g., liquid crystal display (LCD), cathode ray tube (CRT), etc.). The storage device 304 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The server 302 could be a networked computer system, a personal computer, a smart phone, tablet computer etc. It is noted that the server 302 need not be a networked server, and indeed, could be a stand-alone computer system.

The functionality provided by the present disclosure could be provided by a specially-programmed optimized real estate search engine 306, which could be embodied as computer-readable program code stored on the storage device 304 and executed by the CPU 312 using any suitable, high or low level computing language, such as Python, Java, C, C++, C#, .NET, MATLAB, etc. The network interface 308 could include an Ethernet network interface device, a wireless network interface device, or any other suitable device which permits the server 302 to communicate via the network. The CPU 312 could include any suitable single- or multiple-core microprocessor of any suitable architecture that is capable of implementing and running the optimized real estate search engine 306 (e.g., Intel processor). The random access memory 314 could include any suitable, high-speed, random access memory typical of most modern computers, such as dynamic RAM (DRAM), etc.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A property searching system, comprising:
a computer system in electronic communication with an end user computer system and one or more remote data sources over a network;
an optimization database in electronic communication with the computer system, the optimization database including at least one pre-programmed database table identifying a geographic location and a plurality of geographic areas within a predetermined distance of the geographic location;
an optimization engine stored on the computer system which, when executed by the computer system, causes the computer system to:
electronically receive over the network search criteria from the end user computer system, the search criteria including a workplace location and commute criteria;
electronically querying the optimization database to identify a plurality of geographic areas to be searched, each of the plurality of geographic areas satisfying the workplace location and the commute criteria;
electronically querying over the network the one or more remote data sources to identify individual properties located within the plurality of geographic areas to be searched;
filtering the individual properties based on the search criteria to produce a filtered list of individual properties; and
electronically transmitting over the network the filtered list of individual properties to the end user computer system.

2. The property searching system of claim 1, wherein the one or more remote data sources includes Multiple Listing Service (MLS).

3. The property searching system of claim 1, wherein the optimization database includes at least one pre-programmed database table of zip codes based on minimum distances between zip codes.

4. The property searching system of claim 1, wherein the optimization engine electronically retrieves from the one or more remote data sources an actual commute time for each of the individual properties.

5. The property searching system of claim 1, wherein the search criteria includes a first workplace location and corresponding first commute criteria of a first user, as well as a second workplace location and corresponding second commute criteria of a second user.

6. The property searching system of claim 1, wherein the search criteria includes school criteria.

7. The property searching system of claim 6, wherein the optimization database includes at least one pre-programmed database tables of zip codes based on maximum school ratings within each zip code.

8. The property searching system of claim 1, wherein the search criteria includes financial parameters.

9. The property searching system of claim 8, wherein the optimization engine calculates a first maximum price based on a down payment amount.

10. The property searching system of claim 9, wherein the optimization engine calculates a second maximum price for each of the individual properties based on the down payment amount and a monthly cash flow for each of the individual properties.

11. The property searching system of claim 1, wherein the search criteria includes safety criteria.

12. A method for property searching, comprising:
electronically receiving at an optimization engine executed by a computer system search criteria from an end user computer system in electronic communication with the computer system over a network, the search criteria including a workplace location and commute criteria;
electronically querying, by the optimization engine, an optimization database to identify a plurality of geographic areas to be searched, each of the plurality of geographic areas satisfying the workplace location and the commute criteria, the optimization database including at least one pre-programmed database table identifying a geographic location and a plurality of geographic areas within a predetermined distance of the geographic location;
electronically querying, by the optimization engine, one or more data sources to identify individual properties located within the plurality of geographic areas to be searched;
filtering, by the optimization engine, the individual properties based on the search criteria to produce a filtered list of individual properties; and
electronically transmitting, by the optimization engine, the filtered list of individual properties to the end user computer system.

13. The method of claim 12, wherein the one or more data sources includes Multiple Listing Service (MLS).

14. The method of claim 12, wherein the optimization database includes at least one pre-programmed database table of zip codes based on minimum distances between zip codes.

15. The method of claim 12, further comprising electronically retrieving, by the optimization engine, from the one or more remote data sources an actual commute time for each of the individual properties.

16. The method of claim 12, wherein the search criteria includes a first workplace location and corresponding first commute criteria of a first user, as well as a second workplace location and corresponding second commute criteria of a second user.

17. The method of claim 12, wherein the search criteria includes school criteria.

18. The method of claim 17, wherein the optimization database includes at least one pre-programmed database tables of zip codes based on maximum school ratings within each zip code.

19. The method of claim 12, wherein the search criteria includes financial parameters.

20. The method of claim 19, further comprising calculating, by the optimization engine, a first maximum price based on a down payment amount.

21. The method of claim 20, further comprising calculating, by the optimization engine, a second maximum price for each of the individual properties based on the down payment amount and a monthly cash flow for each of the individual properties.

22. The method of claim 12, wherein the search criteria includes safety criteria.

23. A non-transitory computer-readable medium having computer-readable instructions stored thereon which, when executed by a computer system, cause the computer system to perform the steps of:
electronically receiving at an optimization engine executed by the computer system search criteria from an end user computer system in electronic communication with the computer system over a network, the search criteria including a workplace location and commute criteria;
electronically querying, by the optimization engine, an optimization database to identify a plurality of geographic areas to be searched, each of the plurality of geographic areas satisfying the workplace location and the commute criteria, the optimization database including at least one pre-programmed database table identifying a geographic location and a plurality of geographic areas within a predetermined distance of the geographic location;
electronically querying, by the optimization engine, one or more data sources to identify individual properties located within the plurality of geographic areas to be searched;
filtering, by the optimization engine, the individual properties based on the search criteria to produce a filtered list of individual properties; and
electronically transmitting, by the optimization engine, the filtered list of individual properties to the end user computer system.

24. The computer-readable medium of claim 23, wherein the one or more data sources includes Multiple Listing Service (MLS).

25. The computer-readable medium of claim 23, wherein the optimization database includes at least one pre-programmed database table of zip codes based on minimum distances between zip codes.

26. The computer-readable medium of claim 23, further comprising electronically retrieving, by the optimization engine, from the one or more remote data sources an actual commute time for each of the individual properties.

27. The computer-readable medium of claim 23, wherein the search criteria includes a first workplace location and corresponding first commute criteria of a first user, as well as a second workplace location and corresponding second commute criteria of a second user.

28. The computer-readable medium of claim 23, wherein the search criteria includes school criteria.

29. The computer-readable medium of claim 28, wherein the optimization database includes at least one pre-programmed database tables of zip codes based on maximum school ratings within each zip code.

30. The computer-readable medium of claim 23, wherein the search criteria includes financial parameters.

31. The computer-readable medium of claim 30, further comprising calculating, by the optimization engine, a first maximum price based on a down payment amount.

32. The computer-readable medium of claim 31, further comprising calculating, by the optimization engine, a second maximum price for each of the individual properties based on the down payment amount and a monthly cash flow for each of the individual properties.

33. The computer-readable medium of claim 23, wherein the search criteria includes safety criteria.
